(19) United States
(12) Patent Application Publication
(10) Pub. No.: US 2012/0132794 A1
(43) Pub. Date: May 31, 2012

(54) Apparatus And Components Thereof For Liquid Chromatography

(75) Inventors: John Buchanan, Attleboro, MA (US); Edward J. Ognibene, Belmont, MA (US); Peter Kirby, Derry, NH (US)

(73) Assignee: WATERS TECHNOLOGIES CORPORATION, Milford, MA (US)

(21) Appl. No.: 13/264,025

(22) PCT Filed: Apr. 19, 2010
(86) PCT No.: PCT/US10/31554

§ 371 Date: Dec. 12, 2011

Related U.S. Application Data
(60) Provisional application No. 61/170,765, filed on Apr. 20, 2009.

(51) Int. Cl. G01N 30/02; H01J 49/26

(52) U.S. Cl. 250/281; 73/61.52

(57) ABSTRACT

The invention provides chromatographic apparatus and components manufactured from a corrosion resistant alloy typically comprising iron, nickel, chromium and molybdenum. The apparatus and components exhibit superior biocompatibility and corrosion resistance, especially to mobile phases containing chlorides. They are especially useful in HPLC and HPLC, and are particularly useful in conjunction with chromatographic separation media comprising particles smaller than 2 μm diameter.

### RELATED APPLICATIONS

This application claims the benefit of U.S. Provisional Application Ser. No. 61/170,765, filed Apr. 20, 2009, the entirety of which is incorporated herein by reference.

### BACKGROUND TO THE INVENTION

This invention relates to apparatus and components thereof for carrying out liquid chromatography, typically but not exclusively, using separation media comprising particles of 2 μm diameter or smaller. Such chromatography is referred to as herein extreme pressure liquid chromatography.

The use of chromatographic separation media having very small diameters allows superior resolution and shorter separation times to be achieved in comparison with those obtained with the use of larger particles. However, the design and construction of the apparatus necessary for their use presents considerable challenge. Typically, a pump capable of generating a liquid pressure of at least 15,000 psi is necessary to cause a suitable flow of mobile phase through a column comprising the particles, and often a flow as low as 1 or 2 nL/minute is used. Consequently, components such as pumps, detectors, valves, columns and fittings must have a very low dead volume and must be able to withstand very high pressures with a leak rate of less than a few nL/minute (or less). These components must be resistant to corrosion in view of the aggressive nature of many of the mobile phases used in liquid chromatography. The interior surfaces of the components which may be in contact with a mobile phase, especially of connecting tubing, valves and chromatographic separation columns, must also be smooth in order to minimize turbulence and back pressure. Column frits also require careful design and material specification in order that they can withstand the very high liquid pressure and allow sufficient flow while retaining the very small particles of the separation medium. Tubing for many extreme pressure liquid chromatography systems may have to be drawn down to 0.005″ internal diameter while the exterior profile (typically 1/16″ outside diameter) must be maintained smooth and symmetrical in order that piping connectors can be used at very high pressures with minimal leak rates. These requirements place very stringent limitations on the design, selection of materials and manufacturing processes of the components.

Conventionally, one of the several 316 grades of stainless steel has been the material of choice for the manufacture of liquid chromatography components. However, 316 grades of stainless steel show corrosion by certain acidic mobile phases, especially those containing chloride ions. The problem is most severe with systems operating very extreme pressure and at very low flow rates, where excessive corrosion of internal surfaces may impact severely on performance, thereby reducing the lifetime of the equipment.

In the following, the phrase “analytical chromatographic separation” means an analysis of relatively small quantities of a sample by means of a chromatographic separation, usually involving a detector which produces a signal indicative of the presence of constituents of the sample.

### SUMMARY OF THE INVENTION

One embodiment of the invention is directed to one or more components of a chromatographic apparatus for carrying out an analytical chromatographic separation by the passage through a stationary phase of a mobile phase into which a sample has been introduced. The component or components have at least one surface that in use may contact a mobile phase, wherein the at least one surface is formed of an alloy comprising between about 40 and 60% of iron, between about 20 and 26% of nickel, and between about 20 and 22% of chromium. Preferably, the alloy may additionally comprise between about 6 and 7% of molybdenum. Further preferably, the alloy may be a super-austenitic stainless steel, and still further preferably may be an alloy known as AL6XN®. Such an alloy may also be known as AISI type UNS N08367.

The use of these alloys results in better corrosion resistance, especially in respect of use with acidic or chloride-containing mobile phases. The apparatus and components have also been found to have superior compatibility with biochemical samples such as peptides and proteins compared with prior apparatus manufactured from 316 grade stainless steel.

In other embodiments the components described are selected from the group comprising:
a) a pump which in use generates a flow of a the mobile phase through an analytical chromatographic separation column comprising a said stationary phase;
b) tubing through which in use a the mobile phase may flow; the tubing for connecting other of the components;
c) a detector which in use a the mobile phase may flow, and which produces a signal indicative of the presence off a the sample in the mobile phase after it has passed through the stationary phase;
d) a valve through which a the mobile phase may flow, which in use may inject an aliquot of a the sample into the mobile phase;
e) an analytical chromatographic separation column that at least contains particles of a the stationary phase, and through which a the mobile phase may flow, the analytical chromatographic column comprising an enclosure having a the surface which in use may contact the mobile phase;
f) a porous frit which in use is comprised in a the analytical chromatographic column to retain particles of a the stationary phase therein while permitting a the mobile phase to flow through it.

Another embodiment of the invention comprises apparatus for carrying out an analytical chromatographic separation using a mobile phase. The apparatus has at least one component having a surface, which in use, contacts the mobile phase. The at least one surface is formed of an alloy comprising between about 40 and 60% of iron, between about 20 and 26% of nickel, and between about 20 and 22% of chromium. Preferably, the alloy has between about 6 and 7% of molybdenum. Further preferably, the alloy is be a super-austenitic stainless steel, and still further preferably may be an alloy known as AL6XN®. Such an alloy is also be known as AISI type UNS N08367.

Another embodiment comprises tubing as described above which is capable of withstanding a pressure or mobile phase of at least 15,000 psi or preferably at least 20,000 psi. The tubing is manufactured from an alloy comprising between about 40 and 60% of iron, between about 20 and 26% of nickel, and between about 20 and 22% of chromium. Preferably, the alloy has between about 6 and 7% of molybdenum. Further preferably, the alloy is a super-austenitic stainless steel. Such an alloy is known as AL6XN®. Such an alloy is also known as AISI type UNS N08367. Typically such tubing may have a bore of less than about 0.01″ diameter and an external diameter of about 1/16″.

Another embodiment of the invention comprises pipe fittings, including but not limited to, unions, tee connectors, stud connectors and elbows adapted for use with the tubing as described. The fittings are manufactured from an alloy comprising between about 40 and 60% of iron, between about 20 and 26% of nickel, and between about 20 and 22% of chromium. Preferably, the alloy has between about 6 and 7% of molybdenum. Further preferably, the alloy may be a super-austenitic stainless steel. Such an alloy is known as AL6XN®.

Another embodiment of the invention comprises a high-pressure liquid analytical chromatography pump comprising at least one housing in which a piston reciprocates to generate a flow of a mobile phase. At least one of the pistons and the housing has a surface formed of an alloy comprising between about 40 and 60% of iron, between about 20 and 26% of nickel, and between about 20 and 22% of chromium. Preferably, the alloy additionally comprises between about 6 and 7% of molybdenum. Further preferably, the alloy is a super-austenitic stainless steel. Such an alloy is known as AL6XN®. Preferably, the pump is capable of generating a flow of mobile phase at a pressure of at least 15,000 psi.

In another embodiment, the invention an analytical chromatographic separation column comprising an enclosure that contains particles of a chromatographic separation media. The enclosure has a surface formed of an alloy comprising between about 40 and 60% of iron, between about 20 and 26% of nickel, and between about 20 and 22% of chromium. Preferably, the alloy additionally comprises between about 6 and 7% of molybdenum. Further preferably, the alloy may be a super-austenitic stainless steel. Such an alloy is known as AL6XN®. Further preferably, the particles of the chromatographic separation media have diameters of about 2 μm or smaller.

In another embodiment, the invention is an analytical liquid chromatography sample injection valve which in use injects an aliquot of a sample into a flow of mobile phase. The valve comprising at least one surface formed of an alloy comprising between about 40 and 60% of iron, between about 20 and 26% of nickel, and between about 20 and 22% of chromium. Preferably, the alloy additionally comprises between about 6 and 7% of molybdenum. Further preferably, the alloy is a super-austenitic stainless steel, and known as AL6XN®.

Another embodiment of the invention is a porous frit which in use retains particles of a chromatographic separation media in an enclosure. The frit is composed of an alloy comprising between about 40 and 60% of iron, between about 20 and 26% of nickel, and between about 20 and 22% of chromium. Preferably, the alloy comprises between about 6 and 7% of molybdenum. Further preferably, the alloy is a super-austenitic stainless steel, known as AL6XN®. Preferably, the porous frit retains particles of about 2 μm diameter or smaller and withstands a pressure of at least 15,000 psi or greater.

Yet another embodiment of the invention is an analytical liquid chromatography detector which in use produces a signal indicative of the presence or absence of an analyte in a sample. The detector has at least one surface formed of an alloy comprising between about 40 and 60% of iron, between about 20 and 26% of nickel, and between about 20 and 22% of chromium. Preferably, the alloy has between about 6 and 7% of molybdenum. Further preferably, the alloy is a super-austenitic stainless steel, known as AL6XN®.

### BRIEF DESCRIPTION OF THE FIGURES

FIG. 1 is a schematic drawing of an analytical liquid chromatographic apparatus embodying features of the invention;

FIG. 2 is a drawing of tubing embodying features of the present invention;

FIG. 3 is a drawing of a tubing connector embodying features of the present invention;

FIG. 4 is a schematic drawing of a high-pressure analytical chromatography pump embodying features of the invention; and

FIG. 5 is a schematic drawing of an analytical chromatographic separation column embodying features of the invention;

FIG. 6 is a schematic diagram of an analytical chromatographic detector embodying features of the present invention; and

FIG. 7 is a schematic drawing of an analytical chromatographic sample injection valve embodying features of the present invention.

### DETAILED DESCRIPTION OF EMBODIMENTS OF THE INVENTION

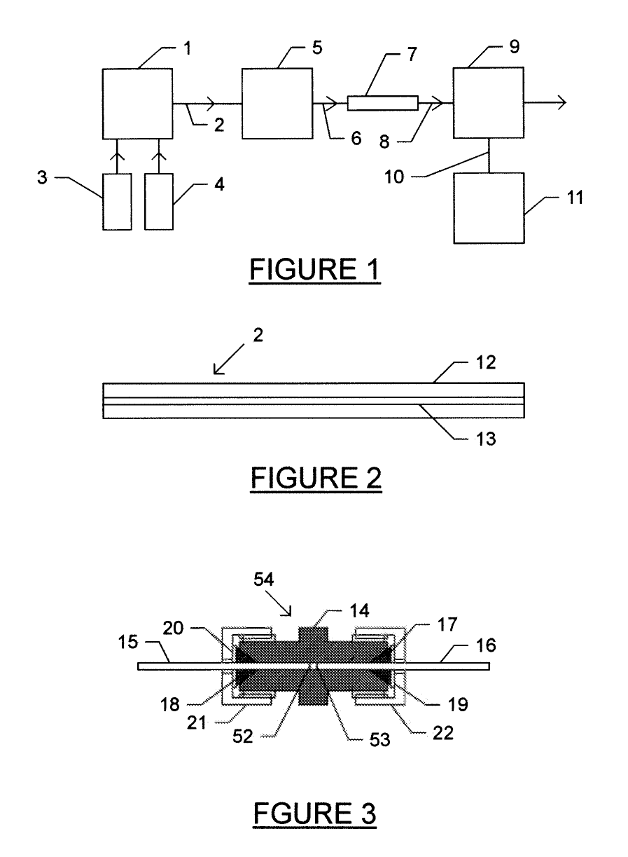

Referring first to FIG. 1, an embodiment of analytical liquid chromatographic apparatus according to the invention comprises an analytical liquid chromatographic pump 1 for generating a flow of a mobile phase in first tubing 2. The mobile phase may comprise a mixture of two or more solvents stored in reservoirs 3, 4, or may comprise a single solvent. As in conventional HPLC, the pump 1 may be capable of providing a mobile phase having a solvent composition which varies with time, for example for carrying out gradient elution chromatography. The first tubing 2 carries the mobile phase to an analytical liquid chromatography sample valve 5 which may be used to inject an aliquot of a sample into the flow of mobile phase. The valve 5 may comprise a six-port sample valve equipped with a sample loop for storing a sample to be injected. In the first position of the valve, the flow of mobile phase passes from the tubing 2 to the second tubing 6 while sample may be introduced into a sample loop (not shown) through a valve port in communication with the sample loop. In a second position of the valve, the mobile phase is caused to flow through the sample loop, carrying with it an aliquot of a sample previously introduced into the sample loop into the second tubing 6.

The flow of mobile phase and the sample aliquot in tubing 6 enters an analytical liquid chromatographic separation column 7 comprising an enclosure which contains particles of a stationary phase. Constituents of the sample may be retained on the stationary phase for different times so they enter the third tubing 8 temporally separated in the flow of mobile phase. An analytical liquid chromatographic detector 9 receives the flow of mobile phase and produces on a connection 10 a signal indicative of the presence of at least some of the constituents present in the sample as they pass through the detector. A computer 11 may receive the signals on connection 10 and may process them in such a way as to produce a chromatogram or otherwise process the data.

As described above in general terms, each of items 1, 2, 5, 6, 7, 8 and 9 identified in FIG. 1 are for the purposes of this invention regarded as components of apparatus for liquid chromatography. It will be appreciated that in practice, analytical chromatographic apparatus may be more complicated than that depicted in FIG. 1, which is merely a schematic representation of a simple version of such a chromatograph. Nevertheless, the basic components shown in FIG. 1 represent the essential components of a practical embodiment of the invention.

Each of the components illustrated in FIG. 1 may comprise a surface which in use may be in contact with the mobile phase. FIG. 2 shows an example of tubing which may be used for the first, second and third tubing (2, 6 & 8 respectively, FIG. 1). The example tubing has an external surface 12 and an interior surface 13 which in use is in contact with the mobile phase flowing through the tube. For HPLC, example 1/16″ diameter tubing 2, 6, and 8 may have an external diameter of

$$0.062 \begin{matrix}+ 0.001 \\ - 0.000\end{matrix}$$

inches and an internal diameter of less than 0.005″, for example

$$0.003 \begin{matrix}+ 0.002 \\ - 0.000\end{matrix}$$

inches. The surface finish of the external surface 12 may be 16Ra maximum and may be free of axial die marks and scratches, thereby ensuring that a compression type fitting may seal to the tubing with a sufficiently low leak rate at the desired operating pressure. The internal surface 13 of the tubing may be free of inorganic and organic contaminants and may have no loose particles therein, thereby minimizing the chance of blockages and ensuring acceptably low levels of chemical interference to an analysis carried out chromatographic apparatus in which the tubing may be incorporated.

In one embodiment of the invention, the tubing 2, 6 and/or 8 is manufactured from an alloy comprising between about 40 and 60% of iron, between about 20 and 26% of nickel, and between about 20 and 22% of chromium. Preferably, the alloy additionally comprises between about 6 and 7% of molybdenum. Further preferably, the alloy is a super-austenitic stainless steel. One such alloy is known as AL6XN®. Such an alloy may also be known as AISI type UNS N08367. Tubing made from these alloys, especially those in which the iron content is less than 50%, is particularly suitable for making the components of analytical liquid chromatography equipment which comprises surfaces in contact with a mobile phase. For example, it has been found that the corrosion rate of such components in the presence of a mobile phase containing chlorides is significantly less than that observed with 316 and 316L stainless steel, the material conventionally used in the past. Tubing according to the invention, manufactured from AL6XN® alloy can be drawn to have dimensions suitable for extreme pressure chromatography, using a mill similar to that used to manufacture similar tubing from 316 grade stainless steel. It has been found that the exterior surface 12 of the tubing drawn in this way may be sufficiently uniform and symmetrical to permit the use of tubing connectors and other fittings (also made of a similar alloy) to be used at the required pressures and with acceptably small leak rates.

A tubing connector 54 suitable for use with the tubing described above and according to the invention, illustrated in FIG. 3, comprises a body 14 into which two lengths of tubing 15, 16 is inserted so that the ends 52, 53 of the tubing are in contact with each other within the body 14. This minimizes the dead volume of the connection. Ferrules 17, 18 engage with conical seats formed in the body 14 and are held tightly in position by washers 19, 20 by nuts 21, 22. The nuts 21 and 22 engage with threads cut on the body 14 and when tightened, exert sufficient force of the ferrules 18 and 19 to ensure a leak-tight seal. Preferably at least the body 14 is manufactured from an alloy comprising between about 40 and 60% of iron, between about 20 and 26% of nickel, and between about 20 and 22% of chromium. Preferably, the alloy additionally comprises between about 6 and 7% of molybdenum. Further preferably, the alloy is a super-austenitic stainless steel. One such alloy is known as AL6XN®. The ferrules 17, 18 may also be manufactured from a similar alloy.

Connectors suitable for extreme pressure apparatus are machined from alloys such as AL6XN®.

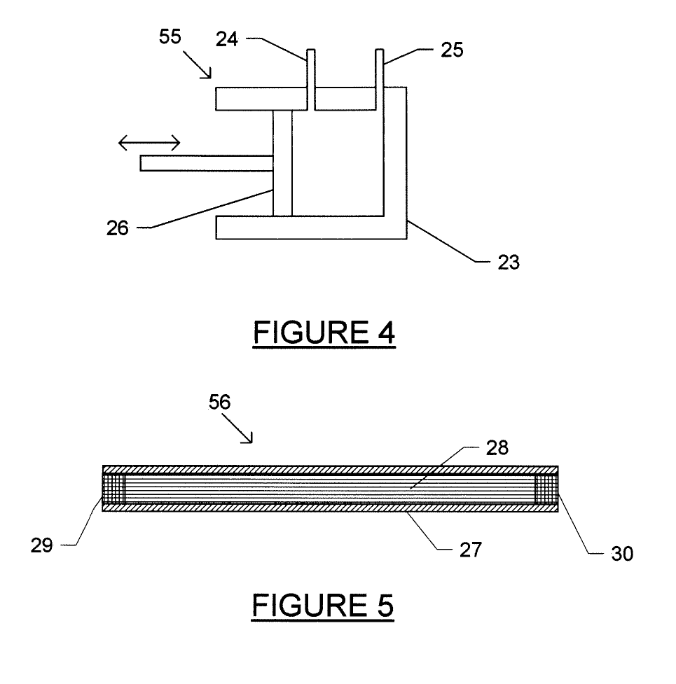

A high-pressure analytical chromatography pump 55 according to the invention is shown schematically in FIG. 4. Such a pump may comprise a housing 23 having an inlet 24 and an outlet 25. A piston 26 reciprocates in the housing 23, forcing a mobile phase which enters the housing 23 through the inlet 24 through the outlet 25 in a conventional manner. One or both of the housing 23 and the piston 24 are manufactured from an alloy comprising between about 40 and 60% of iron, between about 20 and 26% of nickel, and between about 20 and 22% of chromium. Preferably, the alloy additionally comprises between about 6 and 7% of molybdenum. Further preferably, the alloy is a super-austenitic stainless steel. One such alloy is known as AL6XN®.

An analytical chromatographic separation column 56 is illustrated in FIG. 5. It comprises an enclosure 27, typically a cylindrical tube, packed with particles 28 of a chromatographic separation media. Porous frits 29 and 30 are provided to retain the particles 28 within the enclosure. The enclosure may be fitted with unions (not shown) at each end to allow a mobile phase to enter and leave through the frits 29 and 30. One or both of the enclosure 27 and the porous frits 29, and 30 are manufactured with an alloy comprising between about 40 and 60% of iron, between about 20 and 26% of nickel, and between about 20 and 22% of chromium. Preferably, the alloy may additionally comprises between about 6 and 7% of molybdenum. Further preferably, the alloy may be a super-austenitic stainless steel. One such alloy is known as AL6XN®.

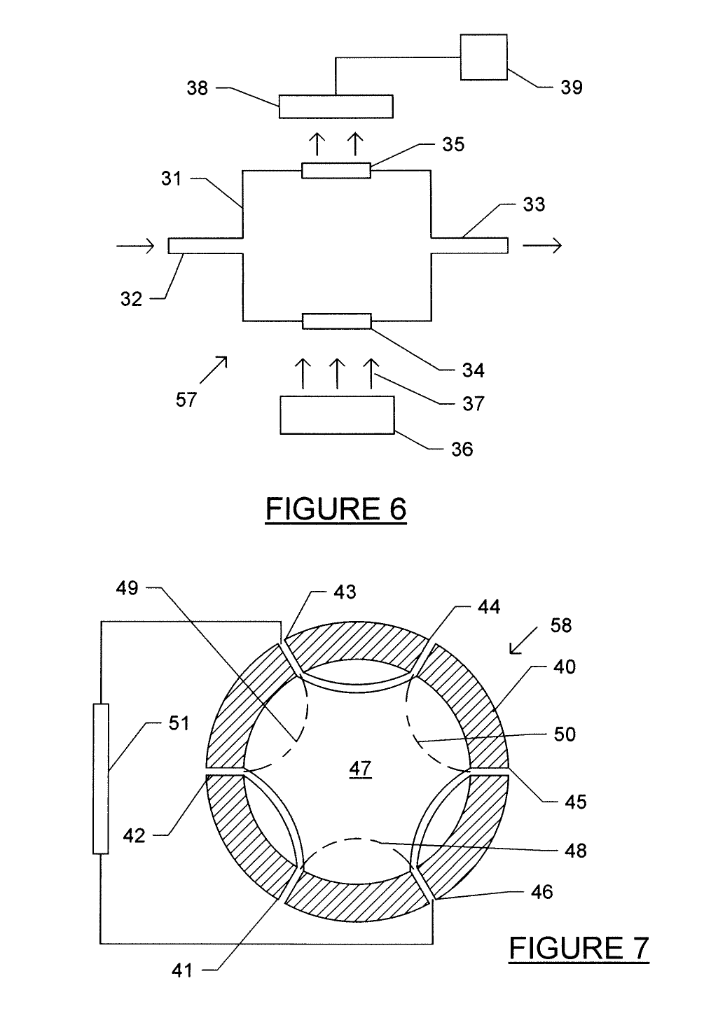

Various types of detectors are used with analytical liquid chromatography, including but not limited to UV absorbance detectors, refractive index detectors, evaporative light scattering detectors, and mass spectrometers. An analytical liquid chromatography detector 57 of the UV absorbance type is schematically illustrated in FIG. 6. It comprises a flow cell 31 having an inlet 32, an outlet 33, and two windows 34, 35 which are transparent to UV radiation. A UV lamp 36 produces a beam of UV radiation 37 which passes through the windows 33 and 34 to be received by a UV-sensitive detector 38. The UV-sensitive detector 38 generates an electrical signal dependent on the intensity of the UV radiation incident upon it. This signal is sent to a data processing device and/or display unit 39 which may generate a chromatogram either in the form of a digital data or a visual display.

In use, a mobile phase exiting from a analytical chromatographic separation column (such as that shown in FIG. 5) is passed into the flow cell 31 thorough the inlet 32 and flows out of the cell via the outlet 33. Typically, the mobile phase itself will be substantially transparent to the UV radiation 37 from the lamp 36. Constituents of a sample eluting from the separation column present in the mobile phase as it enters the flow cell 31 may absorb UV radiation, causing the amount of UV radiation falling on the UV-sensitive detector 38 to change, so that the signal received by the data processing or display unit 39 changes. These indicate the presence and approximate quantity of a sample constituent in the flow cell 31. In one embodiment of the invention, the material from which the flow cell 31 (excluding the windows 34, 35) and the inlets 32 and 33 are made is an alloy comprising between about 40 and 60% of iron, between about 20 and 26% of nickel, and between about 20 and 22% of chromium. Preferably, the alloy comprises between about 6 and 7% of molybdenum. Further preferably, the alloy is a super-austenitic stainless steel. Such an alloy is known as AL6XN®.

Other embodiments of the invention may comprise other types of detectors in which at least parts which in use are in contact with a mobile phase are manufactured from an alloy comprising between about 40 and 60% of iron, between about 20 and 26% of nickel, and between about 20 and 22% of chromium. Preferably, the alloy additionally comprises between about 6 and 7% of molybdenum. Further preferably, the alloy is a super-austenitic stainless steel. Such an alloy known as AL6XN®.

An example of an analytical chromatography sample injection valve 58 is schematically illustrated in FIG. 7. A stator 40 comprises a cylindrical bore and six ports 41-46. A cylindrical rotor 47 is free to rotate within the bore in the stator 40 and makes a substantially liquid-tight seal therewith. The rotor comprises three fluid passages 48-50 which in a first position of the rotor respectively link ports 41 and 46, 42 and 43, 44 and 45. In a second position of the rotor, the fluid passages 48-50 respectively link ports 41 and 42, 43 and 44, 45 and 46. A sample loop 51 is connected between ports 43 and 46 as shown.

In use, a sample is be first introduced into port 44 with the rotor in its first position so that the sample loop 51 is filled as the sample flows through fluid passage 50 and port 45 to waste. The rotor is then be turned into its second position, in which a mobile phase introduced into port 42 flows through fluid passage 49, port 43, sample loop 51 and port 46 to a chromatographic separation column connected to port 41. In this way the sample previously stored in the sample loop 51 is carried to the chromatographic separation column.

In an embodiment of the invention, at least one of the stator 40, the rotor 47 and the sample loop 51 are manufactured from an alloy comprising between about 40 and 60% of iron, between about 20 and 26% of nickel, and between about 20 and 22% of chromium. Preferably, the alloy comprises between about 6 and 7% of molybdenum. Further preferably, the alloy is a super-austenitic stainless steel. Such an alloy is known as AL6XN®.

What is claimed:

1. A component of a chromatographic apparatus for carrying out a analytical chromatographic separation by the passage through a stationary phase of a mobile phase into which a sample has been introduced, said component comprising at least one surface that in use may contact a said mobile phase, wherein said at least one surface is formed of an alloy comprising between about 40 and 60% of iron, between about 20 and 26% of nickel, and between about 20 and 22% of chromium.

2. A component of a chromatographic apparatus as claimed in claim 1 wherein said alloy comprises between about 6 and 7% of molybdenum.

3. A component of a chromatographic apparatus as claimed in claim 1 wherein said alloy is a super-austenitic stainless steel.

4. A component of a chromatographic apparatus as claimed in claim 1 selected from the group comprising:
a) a pump which in use generates a flow of a said mobile phase through an analytical chromatographic separation column comprising a said stationary phase;
b) tubing through which in use a said mobile phase may flow; said tubing for connecting other of said components;
c) a detector which in use a said mobile phase may flow, and which produces a signal indicative of the presence off a said sample in said mobile phase after it has passed through said stationary phase;
d) a valve through which a said mobile phase may flow, which in use injects an aliquot of a said sample into said mobile phase;
e) an analytical chromatographic separation column that at least contains particles of a said stationary phase, and through which a said mobile phase flows, said analytical chromatographic column comprising an enclosure having a surface which in use may contact said mobile phase;
f) a porous frit which in use is comprised in a said analytical chromatographic column to retain particles of a said stationary phase therein while permitting a mobile phase to flow through it.

5. Chromatographic apparatus for carrying out an analytical chromatographic separation using a mobile phase, said apparatus comprising at least one component having a surface which in use may contact said mobile phase, wherein said surface is formed in an alloy comprising between about 40 and 60% of iron, between about 20 and 26% of nickel, and between about 20 and 22% of chromium.

6. Chromatographic apparatus as claimed in claim 5 wherein said alloy comprises between about 6 and 7% of molybdenum.

7. Chromatographic apparatus as claimed in claim 5 wherein said alloy is a super-austenitic stainless steel.

8. A component as claimed in claim 1 comprising tubing which is capable of withstanding a pressure of at least 15,000 psi, said tubing being manufactured from an alloy comprising between about 40 and 60% of iron, between about 20 and 26% of nickel, between about 20 and 22% of chromium, and between about 6 and 7% of molybdenum.

9. A component as claimed in claim 8 wherein said tubing has an external diameter not exceeding about 0.062″ and a bore not exceeding about 0.01″ diameter.

10. A component as claimed in claim 1 comprising one or more pipe fittings selected from the group comprising:
a) unions;
b) tee connectors;
c) stud connectors;
d) elbows;
said one or more pipe fittings being manufactured from an alloy comprising between about 40 and 60% of iron, between about 20 and 26% of nickel, and between about 20 and 22% of chromium, and between about 6 and 7% of molybdenum.

11. A component as claimed in claim 10 wherein said one or more pipe fittings accept tubing having an external diameter not exceeding about 0.062″, have a bore not exceeding about 0.01″ diameter, and are capable of withstanding a pressure of at least 15,000 psi.

12. A component as claimed in claim 1 comprising a high-pressure liquid analytical chromatography pump having at least one housing in which a piston reciprocates to generate a flow of a mobile phase, wherein at least one of said piston and said housing have a surface formed of an alloy comprising between about 40 and 60% of iron, between about 20 and 26% of nickel, between about 20 and 22% of chromium and between about 6 and 7% of molybdenum.

13. A component as claimed in claim 12 wherein said high-pressure liquid analytical chromatography pump is capable of generating a said flow of mobile phase at a pressure of at least 15,000 psi.

14. A component as claimed in claim 1 comprising an analytical chromatographic separation column having an enclosure containing particles of a chromatographic separation media, said enclosure having a surface formed of an alloy comprising between about 40 and 60% of iron, between about 20 and 26% of nickel, between about 20 and 22% of chromium and between about 6 and 7% of molybdenum.

15. A component as claimed in claim 14 wherein said particles of said chromatographic separation media have diameters of about 2 μm or smaller.

16. A component as claimed in claim 1 comprising an analytical liquid chromatography sample injection valve which in use injects an aliquot of a sample into a flow of mobile phase, said valve comprising at least one surface formed of an alloy comprising between about 40 and 60% of iron, between about 20 and 26% of nickel, between about 20 and 22% of chromium, and between about 6 and 7% of molybdenum.

17. A component as claimed in claim 14 further comprising a porous frit which in use may retain particles of a chromatographic separation media in said enclosure, wherein said frit is composed of an alloy comprising between about 40 and 60% of iron, between about 20 and 26% of nickel, between about 20 and 22% of chromium, and between about 6 and 7% of molybdenum.

18. A component as claimed in claim 17 wherein said porous frit is capable of retaining particles of about 2 μm diameter or smaller and is capable of withstanding a pressure of at least 15,000 psi or greater.

19. A component as claimed in claim 1 comprising an analytical liquid chromatography detector which in use produces a signal indicative of the presence of a sample in a flow of mobile phase, said detector comprising at least one surface formed of an alloy comprising between about 40 and 60% of iron, between about 20 and 26% of nickel, between about 20 and 22% of chromium, and between about 6 and 7% of molybdenum.

20. A component as claimed in claim 19 wherein said analytical liquid chromatography detector is selected from the group comprising:
an ultraviolet absorbance detector;
a refractive index detector;
an evaporative light scattering detector;
a mass spectrometer.
